(19) United States
(12) Patent Application Publication
(10) Pub. No.: US 2018/0075396 A1
(43) Pub. Date: Mar. 15, 2018

(54) WORKFLOW MANAGEMENT APPARATUS AND CONTROL PROGRAM OF THE WORKFLOW MANAGEMENT APPARATUS

(71) Applicant: Konica Minolta, Inc., Tokyo (JP)

(72) Inventors: Tomoaki NAKAJIMA, Hyogo-ku (JP); Kaitaku OZAWA, Nishinomiya-shi (JP); Masao HOSONO, Itami-shi (JP); Toshikazu KAWAGUCHI, Kobe-shi (JP); Kenichi TAKAHASHI, Osaka (JP); Daisuke NAKANO, Kobe-shi (JP)

(73) Assignee: Konica Minolta, Inc., Tokyo (JP)

(21) Appl. No.: 15/696,892

(22) Filed: Sep. 6, 2017

(30) Foreign Application Priority Data
Sep. 9, 2016 (JP) 2016-177126

(51) Int. Cl. G06Q 10/06

(52) U.S. Cl. CPC G06Q 10/063114; G06Q 10/06316

(57) ABSTRACT

Provided is a workflow management apparatus that manages a registered workflow, wherein a work procedure order is associated with a work procedure and a worker who is to do the work procedure in the workflow, and the workflow management apparatus includes: a hardware processor that: obtains biological information, the biological information being read with a biological information reading device for reading biological information about a wearer of the device, the biological information being about at least a worker of the workflow; identifies a next procedure worker who makes the registered workflow stagnant when the workflow is stagnant; and determines according to the biological information whether to remind the next procedure worker to do a procedure.

Japanese Patent Application No. 2016-177126 filed on Sep. 9, 2016, including description, claims, drawings, and abstract the entire disclosure is incorporated herein by reference in its entirety.

### BACKGROUND

### Technological Field

The present invention relates to a workflow management apparatus and a control program of the workflow management apparatus. In particular, the present invention relates to a workflow management apparatus and a control program of the workflow management apparatus, which are used to efficiently send a reminder for a procedure of a workflow.

### Description of the Related art

There are electrographic image forming apparatuses such as: a Multi Function Peripheral (MFP) including a scanner function, a facsimile function, a reproducing function, a function as a printer, a data communication function, and a server function; a facsimile device; a copying machine; and a printer.

Some MFPs have a function for managing a workflow with the MFP. A workflow is a flow of a plurality of procedures. When receiving registration of a workflow, such an MFP sequentially performs the procedures prescribed in the workflow according to the operation by a worker.

If a procedure of the workflow has been stagnant for a certain period of time or longer, the MFP reminds the worker who causes the stagnation of the workflow to do the procedure. Existing technologies for reminding a worker to do a procedure are disclosed, for example, in JP 2004-220529 A and JP 2015-46065 A.

JP 2004-220529 A discloses a technique for detecting stagnation in a workflow process with a stagnation detector at a predetermined timing, and reminding a worker to do the process of the workflow by making a call to a next person with authority, who approves or finally decides whether to adopt the application in the workflow, to give the next person a voice via a communication controller.

JP 2015-46065 A discloses an information processing apparatus that informs a message source user who sends a message of the message destination user's mood before the source user sends the message. The information processing apparatus includes a gathering unit that gathers the biological information obtained from the user, a determination unit that determines the user's feeling with the biological information gathered with the gathering unit, and an output unit that associates the information about the user with the user's feeling determined with the determination unit and outputs the associated information to a terminal device that another user uses.

However, the worker causing the progress stagnation in the workflow sometimes does not do a procedure for which a reminder is sent from the MFP to the worker and leaves the procedure, for example, because the worker is doing another procedure or is in a bad mood (feels stressed). As a result, the existing technologies may fail to efficiently remind such a worker to do the stagnant procedure.

In particular, for example, when a workflow registered on the MFP includes a request sent from a worker who has registered the workflow to the worker's supervisor (for example, a request for authorizing the worker who has registered the workflow to use the MFP), reminders may uselessly be sent to the supervisor.

### SUMMARY

The present invention has been made to solve such problems, and an object of the present invention is to provide a workflow management apparatus and a control program of the workflow management apparatus, which are capable of efficiently sending a reminder for a procedure of a workflow.

To achieve the abovementioned object, according to an aspect of the present invention, there is provided a workflow management apparatus that manages a registered workflow, wherein a work procedure order is associated with a work procedure and a worker who is to do the work procedure in the workflow, and the workflow management apparatus reflecting one aspect of the present invention comprises:

a hardware processor that:

obtains biological information, the biological information being read with a biological information reading device for reading biological information about a wearer of the device, the biological information being about at least a worker of the workflow;

identifies a next procedure worker who makes the registered workflow stagnant when the workflow is stagnant; and

determines according to the biological information whether to remind the next procedure worker to do a procedure.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a conceptual diagram of a configuration of a workflow management system according to a first embodiment of the present invention;

FIG. 2 is a block diagram of a hardware configuration of an MFP according to the first embodiment of the present invention;

FIG. 3 is a block diagram of a hardware configuration of a biological information terminal according to the first embodiment of the present invention;

FIG. 4 is a block diagram of a hardware configuration of a biological information server according to the first embodiment of the present invention;

FIG. 5 is a diagram of an outline of an operation of the workflow management system according to the first embodiment of the present invention;

FIG. 6 is a schematic diagram of a biological information table according to the first embodiment of the present invention;

FIG. 7 is a schematic diagram of the content of a workflow to be registered by a user in the first embodiment of the present invention;

FIG. 8 is a schematic diagram of a workflow management table immediately after the user registers the workflow in the first embodiment of the present invention;

FIG. 9 is a schematic diagram of time variations in systolic blood pressure value of each of the users monitored with MFP in a process according to the first embodiment of the present invention;

FIG. 10 is a schematic diagram of a user information table according to the first embodiment of the present invention;

FIG. 11 is a diagram of an outline of an operation of the workflow management system according to the first embodiment of the present invention after reminding the user to do a procedure;

FIG. 12 is a schematic diagram of the workflow management table according to the first embodiment of the present invention immediately after the user completes the procedure;

FIG. 13 is a schematic diagram of time variations in systolic blood pressure value of the user monitored with MFP in a process according to the first embodiment of the present invention;

FIG. 14 is a schematic diagram of another exemplary time variations in systolic blood pressure value of the user monitored with MFP in a process according to the first embodiment of the present invention;

FIG. 15 is a diagram of an outline of an operation of the workflow management system according to a second embodiment of the present invention;

FIG. 16 is a schematic diagram of the content of a workflow to be registered by a user according to the second embodiment of the present invention;

FIG. 17 is a schematic diagram of a workflow management table immediately after the user registers the workflow in the second embodiment of the present invention;

FIG. 18 is a schematic diagram of time variations in systolic blood pressure value of each of users monitored with MFP in a process according to the second embodiment of the present invention;

FIG. 19 is a flowchart of an operation of the MFP according to each of the first and second embodiments of the present invention;

FIG. 20 is a diagram of an outline of an operation of a workflow management system according to a modification of the first and second embodiments of the present invention; and

FIG. 21 is a schematic diagram of the content of a workflow to be registered by a user in the modification of the first and second embodiments of the present invention.

### DETAILED DESCRIPTION OF EMBODIMENTS

Hereinafter, one or more embodiments of the present invention will be described with reference to the drawings. However, the scope of the invention is not limited to the disclosed embodiments.

An MFP will be described as the workflow management apparatus in embodiments to be described below. The workflow management apparatus may be an image forming apparatus that is not an MFP, such as a printer, a copying machine, or a facsimile. Alternatively, the workflow management apparatus may be, for example, a PC, a mobile phone, or a smartphone.

### First Embodiment

First, a configuration of a workflow management system according to the present embodiment will be described.

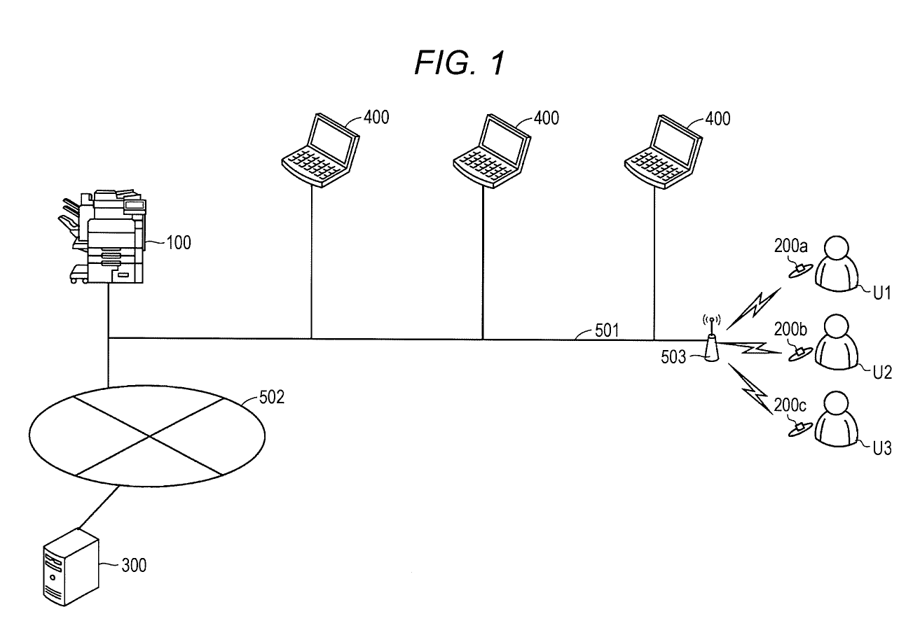

FIG. 1 is a conceptual diagram of a configuration of a workflow management system according to the first embodiment of the present invention.

With reference to FIG. 1, the workflow management system according to the present embodiment includes an MFP 100 (an example of the workflow management apparatus), biological information terminals 200a, 200b, and 200c (examples of a biological information reading device) (hereinafter, the terminals will sometimes be represented as a biological information terminal 200), a biological information server 300, and a plurality of terminals 400. The MFP 100, each of the biological information terminals 200, and each of the terminals 400 are connected to each other via an intranet 501, and communicate with each other. At the same time, these devices on the intranet 501 and the biological information server 300 are connected via the Internet 502, and communicate with each other. In particular, each of the biological information terminals 200 communicates with the other devices via wireless communications with an access point 503 connected to the intranet 501.

Users U1, U2, and U3 wear the biological information terminals 200a, 200b, and 200c, respectively. The biological information terminal 200 measures (reads) a systolic blood pressure value that is the biological information about the wearer.

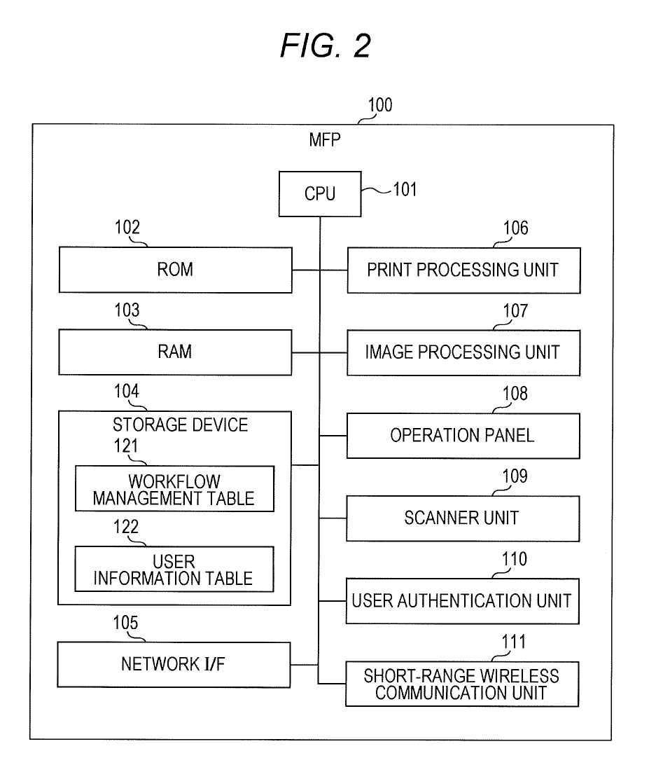

FIG. 2 is a block diagram of a hardware configuration of the MFP 100 according to the first embodiment of the present invention.

With reference to FIG. 2, the MFP 100 includes, for example, a Central Processing Unit (CPU) 101, a Read Only Memory (ROM) 102, a Random Access Memory (RAM) 103, a storage device 104, a network interface 105, a print processing unit 106, an image processing unit 107, an operation panel 108, a scanner unit 109, a user authentication unit 110, and a short-range wireless communication unit 111. The CPU 101 is connected to the ROM 102, the RAM 103, the storage device 104, the network interface 105, the print processing unit 106, the image processing unit 107, the operation panel 108, the scanner unit 109, the user authentication unit 110, and the short-range wireless communication unit 111 via a bus.

The CPU 101 controls the whole MFP 100 for various jobs such as a scan job, a copy job, a mail delivery job, and a print job. In addition, the CPU 101 executes a control program stored in the ROM 102.

The ROM 102 is, for example, a flash ROM. Various programs to be executed by the CPU 101 and various fixed data are stored on the ROM 102. The ROM 102 may be not rewritable.

The RAM 103 is a main memory of the CPU 101. The RAM 103 is used, for example, to temporarily store the data necessary when the CPU 101 executes each program and image data.

The storage device 104 includes, for example, a Hard Disk Drive (HDD) on which various data such as a workflow management table 121 and a user information table 122 to be described below. In addition, an application program for managing workflows is stored on the storage device 104.

The network interface 105 communicates with the other devices in a communication protocol such as TCP/IP according to the instructions from the CPU 101.

The print processing unit 106 performs a printing process for forming an image, for example, on a sheet according to the image data processed in the image processing unit 107.

The image processing unit 107 performs a Raster Image Processing (RIP) to process the image data, or a conversion process to convert the format of data when the data is transmitted to the outside.

The operation panel 108 includes a display unit including a touch-panel display, and an input unit including a hardware key and a software key displayed on the touch-panel display. The operation panel 108 receives various types of input from the user and displays various setting items, or a message to the user.

The scanner unit 109 reads an image of an original.

The user authentication unit 110 authenticates the user, for example, based on the user ID and password stored on the biological information terminal 200 held by each user or the user ID and password input from the operation panel 108, and allows the user to use the MFP 100.

The short-range wireless communication unit 111 performs wireless communications, for example, with the biological information terminal 200 in a short-range wireless communication standard such as Bluetooth®.

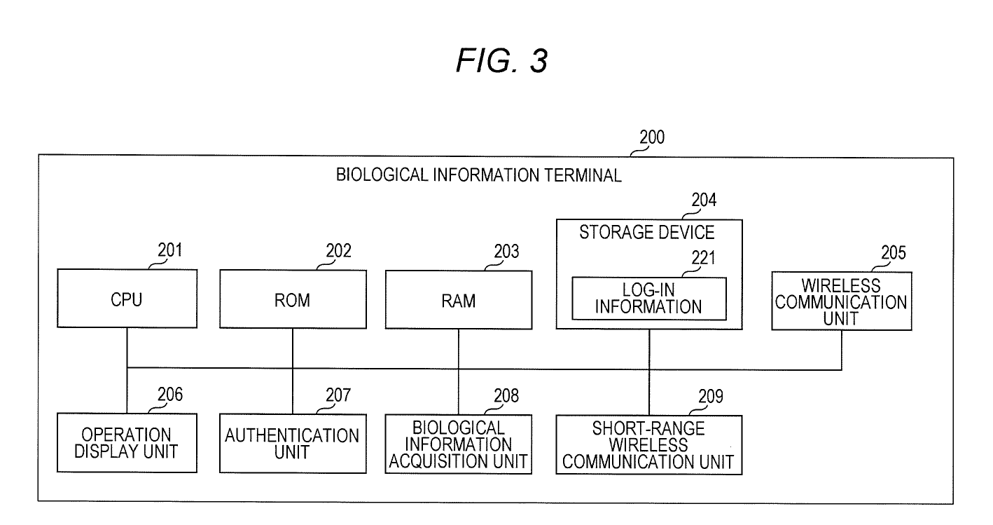

FIG. 3 is a block diagram of a hardware configuration of the biological information terminal 200 according to the first embodiment of the present invention.

With reference to FIG. 3, the biological information terminal 200 is put on the user's body such as the hand or the arm. The biological information terminal 200 includes a CPU 201, a ROM 202, a RAM 203, a storage device 204, a wireless communication unit 205, an operation display unit 206, an authentication unit 207, a biological information acquisition unit 208, and a short-range wireless communication unit 209. The CPU 201 is connected to the ROM 202, the RAM 203, the storage device 204, the wireless communication unit 205, the operation display unit 206, the authentication unit 207, the biological information acquisition unit 208, and the short-range wireless communication unit 209 via a bus.

The CPU 201 controls the operations of the whole biological information terminal 200. The CPU 201 performs a process according to a control program.

For example, a control program executed by the CPU 201 is stored on the ROM 202.

The RAM 203 is a memory used when the CPU 201 operates and various types of information are temporarily stored on the RAM 203.

Various types of information such as the information necessary to biometrically authenticate the user wearing the biological information terminal 200 (for example, a vein pattern used for vein authentication), the login information 221 about the user of the biological information terminal 200 are stored on the storage device 204. The login information is required when the user wearing the biological information terminal 200 logs in the other device and includes, for example, the user ID and the password.

The wireless communication unit 205 transmits and receives various types of information to/from the other devices including the MFP 100 via the access point 503.

The operation display unit 206 displays various types of information and receives various types of input from the user of the biological information terminal 200.

The authentication unit 207 biometrically authenticates the user wearing the biological information terminal 200. Biometrical authentication methods may be methods using physical characteristics, for example, vein authentication, pulse wave authentication, fingerprint authentication, and iris authentication.

The biological information acquisition unit 208 measures the biological information about the user wearing the biological information terminal 200. The biological information terminal 200 measures a systolic blood pressure value in the embodiments. However, the biological information terminal 200 may measure the biological information other than the systolic blood pressure value, for example, a pulse rates, a body temperature, a diastolic blood pressure value, a heart rate, a respiratory rate, or brain waves.

The short-range wireless communication unit 209 performs wireless communications, for example, with the MFP 100 according to a short-range wireless communication standard such as Bluetooth®.

Note that the biological information terminal 200 may be a mobile Identification (ID) terminal. When the user wearing such a mobile ID terminal as the biological information terminal 200 approaches a device such as the MFP 100, the biological information terminal 200 transmits the login information 221 to the MFP 100 in the short-range wireless communications. The MFP 100 performs a login process for enabling the user to log in the MFP 100 based on the received information. This process enables to the user wearing the biological information terminal 200 to use the MFP 100 without performing a logging in process.

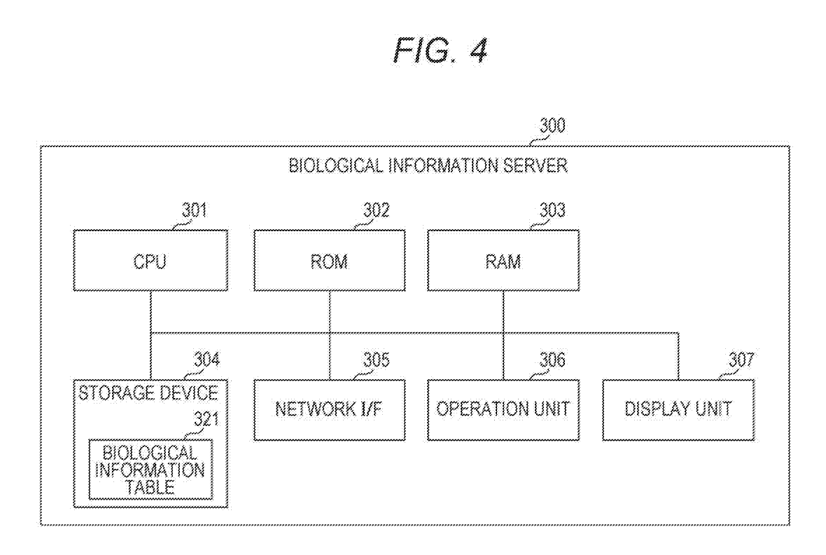

FIG. 4 is a block diagram of a hardware configuration of a biological information server 300 according to the first embodiment of the present invention.

With reference to FIG. 4, the biological information server 300 is, for example, a PC, and includes, for example, a CPU 301, a ROM 302, a RAM 303, a storage device 304, a network interface 305, an operation unit 306, and a display unit 307. The CPU 301 is connected to the ROM 302, the RAM 303, the storage device 304, the network interface 305, the operation unit 306, and the display unit 307 via a bus.

The CPU 301 controls the whole biological information server 300. In addition, the CPU 301 executes a control program stored on the ROM 302.

The ROM 302 is, for example, a flash ROM. Various programs to be executed by the CPU 301 and various fixed data are stored on the ROM 302. The ROM 302 may be not rewritable.

The RAM 303 is a main memory of the CPU 301. The RAM 303 is used, for example, to temporarily store the data necessary when the CPU 301 executes the control program.

The storage device 304 includes, for example, an HDD on which various data such as a biological information table 321 to be described below.

The network interface 305 communicates with the other devices in a communication protocol such as TCP/IP according to the instructions from the CPU 301.

The operation unit 306 receives various instructions from the user.

The display unit 307 displays the various types of information.

Note that the configuration of the terminal 400 is almost the same as the configuration of the biological information server 300 expect that the biological information table 321 is not stored on the terminal 400. Thus, the description will not be repeated.

The operation of the workflow management system according to the present embodiment will be described next.

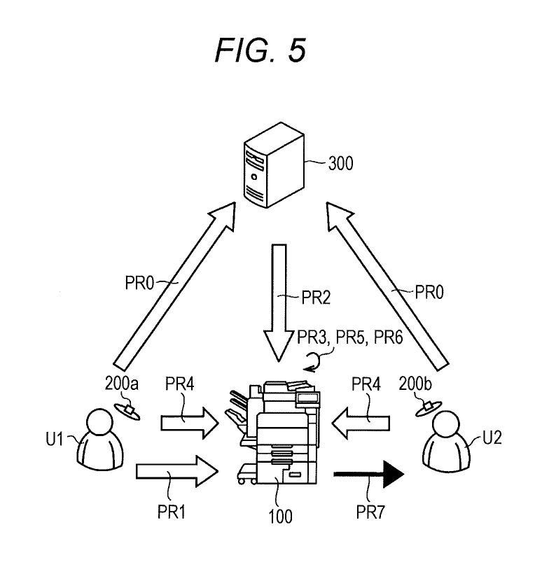

FIG. 5 is a schematic diagram of the operation of the workflow management system according to the first embodiment of the present invention.

With reference to FIG. 5, the biological information terminals 200a and 200b are put on the users U1 and U2, respectively. When biometrically authenticating the user U1 successfully, the biological information terminal 200a starts measuring the systolic blood pressure value of the user U1. The biological information terminal 200a transmits the measured systolic blood pressure value together with the user ID of the user U1 to the biological information server 300 at predetermined intervals (at one-minute intervals in the present embodiment) (a process PRO). Similarly, when biometrically authenticating the user U2 successfully, the biological information terminal 200b starts measuring the systolic blood pressure value of the user U2. The biological information terminal 200b transmits the measured systolic blood pressure value together with the user ID of the user U2 to the biological information server 300 at predetermined intervals (at one-minute intervals in the present embodiment) (a process PRO).

Every time receiving the systolic blood pressure value from each of the biological information terminals 200a and 200b, the biological information server 300 adds the received systolic blood pressure value to a space for each user in the biological information table 321.

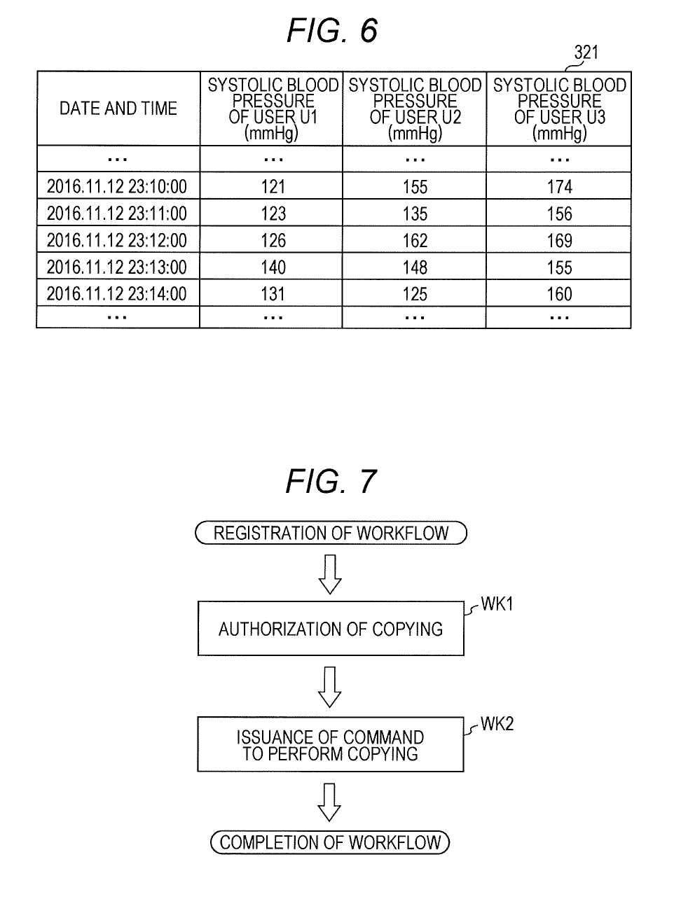

FIG. 6 is a schematic diagram of the biological information table 321 according to the first embodiment of the present invention.

With reference to FIGS. 5 and 6, the biological information table 321 is a record of the history of the biological information about the users of the biological information terminals 200, and includes the date and time and the systolic blood pressure value (mm Hg).

In specific, the systolic blood pressure values of the users U1, U2, and U3 transmitted every minute from 23:10 on Nov. 12th, 2016 are recorded in the biological information table 321 illustrated in FIG. 6. The systolic blood pressure value of the user U1 varies from “121 mm Hg” through “123 mm Hg”, “126 mm Hg”, and “140 mm Hg” to “130 mm Hg”.

With reference to FIG. 5, after the MFP 100 starts obtaining the systolic blood pressure value of each of the users U1 and U2, the user U1 inputs the registration of a workflow in which the users U1 and U2 are included as workers into the MFP 100 via the operation panel 108 or the terminal 400. The MFP 100 receives the registration of the workflow, and registers the workflow on the workflow management table 121 (a process PRO.

The MFP 100 obtains the history of the systolic blood pressure value of each of the users U1 and U2 who is to do the workflow as its workers, which is recorded before the MFP 100 receives the registration of the workflow, from the biological information server 300 (a process PR2). The MFP 100 determines the normal range of the systolic blood pressure value (an example of a specific range of the biological information) of each of the users U1 and U2 according to the obtained history of the systolic blood pressure value (a process PR3).

In the process PR3, the MFP 100 may determine, for example, a range of the values equal to or lower than the average value of the systolic blood pressure values in the history as the normal range of the systolic blood pressure value. Alternatively, the MFP 100 may determine fixed values as the normal range of the systolic blood pressure value regardless of the history of the systolic blood pressure value, or may determine the range input by the user who registers the workflow as the normal range of the systolic blood pressure. Furthermore, the MFP 100 may determine a normal range for a plurality of workers.

The normal range of the biological information is not necessarily a numerical range. For example, when the MFP 100 obtains brain waves as the biological information, the MFP 100 may determine a range of degree of similarity between the obtained brain waves and reference normal brain waves as the normal range.

FIG. 7 is a schematic diagram of the content of the workflow to be registered by the user U1 in the first embodiment of the present invention.

With reference to FIGS. 5 and FIG. 7, it is assumed in the present embodiment that the user U1 who does not have the authority to print a color copy requests the user U2 who has the authority to print a color copy to authorize the user U1 to print 50 color copies. The workflow to be registered by the user U1 includes a procedure in which the user U2 authorizes the user U1 to make 50 color copies in the MFP 100 (a procedure WK1), and a procedure in which the user U1 issues a command to perform the color copying to the MFP 100 after the authorization (a procedure WK2). The workers of the workflow are the users U1 and U2. The worker who is to do the last procedure of the workflow is the user U1 who has registered the workflow.

Each of a plurality of procedures of a workflow registered in the workflow management table is preferably performed with the MFP 100.

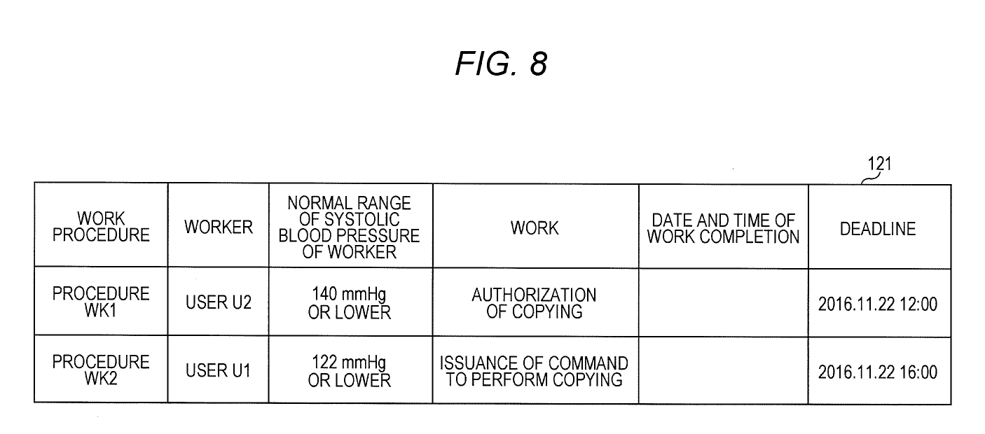

FIG. 8 is a schematic diagram of the workflow management table 121 immediately after the user U1 registers the workflow in the first embodiment of the present invention.

With reference to FIGS. 5 and 8, every time a new workflow is registered, the MFP 100 creates a new workflow management table 121 of the new workflow and stores the new table on the storage device 104.

The workflow management table 121 is a record of the information about the registered workflow, and includes the work procedure (the procedure order), the worker, the normal range of the systolic blood pressure value of the worker, the work, the date and time of work completion, and the deadline. The workflow management table 121 may further include the information about the person who registers the workflow.

In specific, the workflow in which the user U2 authorizes the user U1 to make a copy in the procedure

B42350US01 WK1, and then the user U1 issues a command to perform the copying in the procedure WK2 is written in the workflow management table 121 illustrated in FIG. 8. Furthermore, the facts that the normal range of the systolic blood pressure value of the user U2 is “140 mm Hg or lower” and the normal range of the systolic blood pressure value of the user U1 is “122 mm Hg or lower” are also written. Furthermore, the facts that the deadline of the procedure WK1 is “12:00 on Nov. 22nd, 2016” and the deadline of the procedure WK2 is “16:00 on Nov. 22nd, 2016” are also written.

Note that the MFP 100 needs at least to receive the registration of the worker who is to do the workflow, and the order of the procedures of the workers, the work, and the deadline are not necessarily included in the registered content.

With reference to FIG. 5, when receiving the registration of a workflow, the MFP 100 starts monitoring (obtaining) the systolic blood pressure value of each of the users U1 and U2 who are the workers of the workflow (a process PR4). The MFP 100 may obtain the systolic blood pressure values of the users U1 and U2 directly from the biological information terminals 200a and 200b, respectively, or may obtain the systolic blood pressure values from the biological information server 300 indirectly.

When receiving the registration of a workflow, the MFP 100 determines whether the workflow is stagnant (a process PR5).

It is assumed in the present embodiment that the procedure to be done by the user U2 (authorization of copying (the procedure WK1) illustrate in FIG. 7) in the workflow is not completed, and thus a next procedure worker who is the worker to do the procedure to be done next in the workflow is the user U2.

The MFP 100 may determine that the workflow is stagnant when receiving the input for confirming the progress of the workflow via the operation panel 108 or the terminal 400. Alternatively, the MFP 100 may determine that the workflow is stagnant when a period of time that has elapsed since the procedure to be done next is allowed to be done exceeds a predetermined period of time, or when the deadline is coming soon.

When determining that the workflow is stagnant, the MFP 100 determines, according to whether the obtained systolic blood pressure value is within the normal range, whether to remind the user U2 to do the procedure (a process PR6). If there is a plurality of next procedure workers, such determination is performed for each next procedure worker.

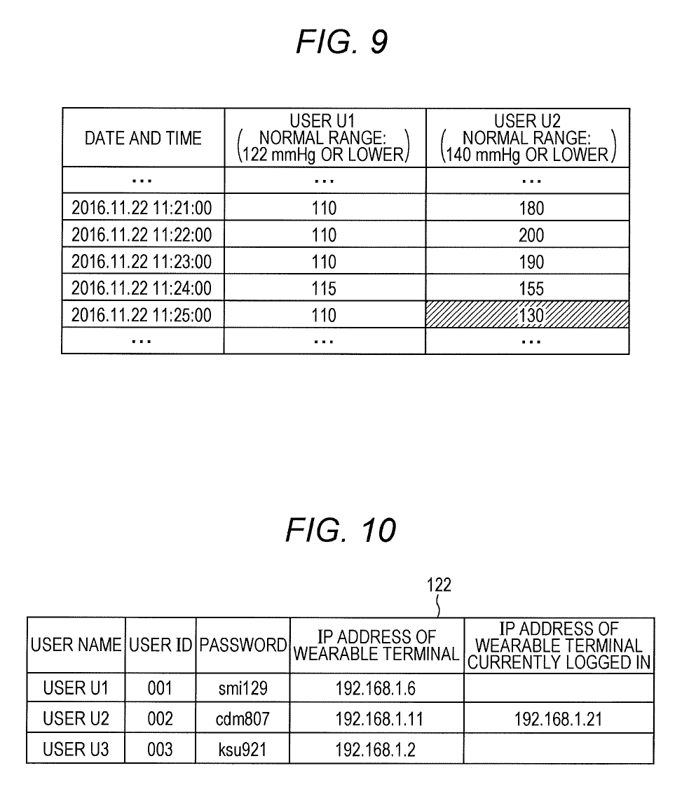

FIG. 9 is a schematic diagram of time variations in systolic blood pressure value of each of the users U1 and U2 monitored with the MFP 100 in the process PR6 according to the first embodiment of the present invention.

With reference to FIGS. 5 and 9, if the systolic blood pressure value of the user U2 currently monitored is beyond the normal range, the MFP 100 determines not to remind the user U2 to do the procedure. The user U2 is presumed to feel stressed and be in a bad mood when the systolic blood pressure value of the user U2 currently monitored is beyond the normal range. When the user U2 is in such a condition, a reminder for a procedure is highly likely to make the user U2 feel discomfort.

On the other hand, if the systolic blood pressure value of the user U2 currently monitored is within the normal range, the MFP 100 determines to remind the user U2 to do the procedure. The user U2 is presumed to feel less stressed and be at rest when the systolic blood pressure value of the user U2 currently monitored is within the normal range. When the user U2 is in such a condition, a reminder for a procedure is less likely to make the user U2 feel discomfort.

In specific, the systolic blood pressure value of the user U2 is beyond the normal range from 11:21 on Nov. 22nd, 2016 to 11:24 on the same day. Accordingly, the MFP 100 determines not to send a reminder during the time period. On the other hand, the systolic blood pressure value of the user U2 is within the normal range at 11:25 on Nov. 22nd, 2016. Accordingly, the MFP 100 determines to send a reminder at that time.

In the process PR6, according to whether the systolic blood pressure value of the user U1 (the procedure-after-next worker) who is to do the procedure (the procedure WK2) after the procedure to be done next (the procedure WK1) is within the normal range, the MFP 100 may determine whether to remind the user U2 to do the procedure.

With reference to FIG. 5, if the MFP 100 determines to remind the user U2 to do the procedure, a displayed message or a sound may be used for the reminder for the procedure to the user U2 (a process PR7). The MFP 100 may send a reminder for a procedure to the biological information terminal 200b that the user U2 wears. Alternatively, the MFP 100 may send a reminder for the procedure to the device that the user U2 logs in with the biological information terminal 200b (the MFP 100 or the terminal 400).

In the process PR7, the MFP 100 identifies the biological information terminal 200b that the user U2 wears or the device that the user U2 logs in with reference to the user information table 122 to send a reminder for the procedure.

FIG. 10 is a schematic diagram of the user information table 122 according to the first embodiment of the present invention.

With reference to FIGS. 5 and 10, the user information table includes the user ID and password of the user registered in the MFP 100, the Internet Protocol (IP) address of the biological information terminal 200, and the IP address of the terminal 400 currently logged in.

In specific, the fact that the user U2 has a user ID “002” and a password “cdm807”, wears the biological information terminal 200 having an IP address “192.168.1.11”, and currently logs in the terminal 400 having an IP address “192.168.1.21” is written in the user information table 122 illustrated in FIG. 10.

The user ID and password, and the IP address of the biological information terminal 200 in the user information table 122 are input by the user or the person who manages the MFP 100. When the terminal 400 receives a user login, the terminal 400 notifies the MFP 100 of the user login. When receiving the notification, the MFP 100 registers the IP address of the terminal 400 that is the notification source on a space for the IP address of the terminal 400 currently logged in in the user information table 122.

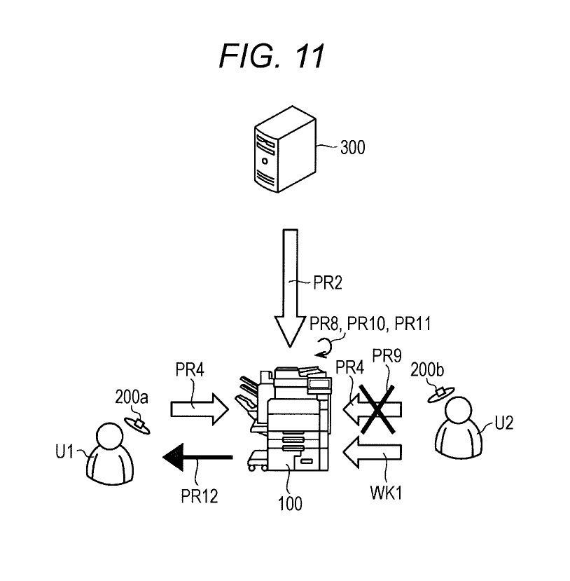

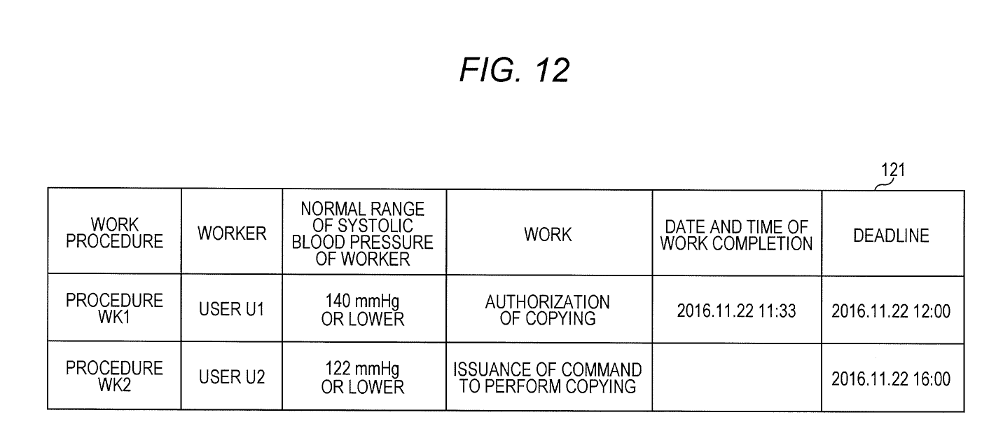

FIG. 11 is a diagram of an outline of an operation of the workflow management system according to the first embodiment of the present invention after reminding the user U2 to do a procedure. FIG. 12 is a schematic diagram of the workflow management table 121 according to the first embodiment of the present invention immediately after the user U2 completes the procedure.

With reference to FIGS. 11 and 12, the MFP 100 determines that the work procedure is completed when performing the work written in the workflow management table 121 according to the performance command issued by the worker, or when receiving the pressure of the key, which is for notifying the completion of work and displayed on the operation panel 108.

When the user U2 completes the procedure (the procedure WK1), the MFP 100 enters the time and data of the completion in a space for the date and time of work completion of the procedure WK1 in the workflow management table 121, and then sends a request for the next work to the biological information terminal 200a that the user U1, who is the worker to do the next work, wears (a process PR8). The date and time “11:33 on Nov. 22nd, 2016” is written in the space for the date and time of work completion of the procedure WK1 in the workflow management table 121 illustrated in FIG. 12.

Furthermore, when the user U2 completes the procedure, the MFP 100 stops obtaining (monitoring) the systolic blood pressure value of the user U2 (a process PR9). The MFP 100 continues obtaining the systolic blood pressure value of the user U1 after the user U2 completes the procedure.

Next, the MFP 100 determines in a manner similar to the process PR5 whether the workflow is stagnant (a process PR10).

It is assumed in the present embodiment that the user U1 does not notice that the user U2 completes the authorization for copying in the workflow (the procedure WK1 illustrated in FIG. 7), and the user U1 makes the issuance of a command to perform the copying (the procedure WK2 illustrated in FIG. 7) stagnant. The next procedure worker is the user U1.

When determining that the workflow is stagnant, the MFP 100 determines whether to remind the user UI to do the procedure according to whether the systolic blood pressure value of the user U1 is within the normal range (a process PR11).

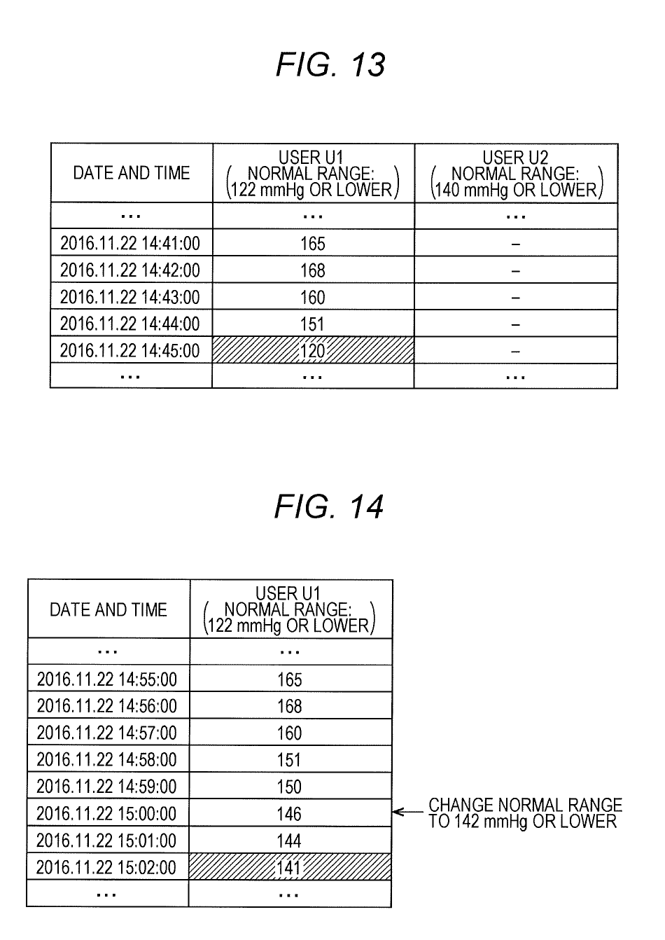

FIG. 13 is a schematic diagram of time variations in systolic blood pressure value of the user U1 monitored with the MFP 100 during the process PR11 according to the first embodiment of the present invention.

With reference to FIGS. 11 and 13, the MFP 100 determines not to remind the user U1 to do the procedure when the systolic blood pressure value of the user U1 currently monitored is beyond the normal range. On the other hand, the MFP 100 determines to remind the user U1 to do the procedure when the systolic blood pressure value of the user U1 currently monitored is within the normal range.

In specific, the systolic blood pressure value of the user U1 is beyond the normal range from 14:41 on Nov. 22nd, 2016 to 14:44 on the same day. Accordingly, the MFP 100 determines not to send a reminder during the time period. On the other hand, the systolic blood pressure value of the user U1 is within the normal range at 14:45 on Nov. 22nd, 2016. Accordingly, the MFP 100 determines to send a reminder at that time.

When determining to remind the user U1 to do the procedure, the MFP 100 sends a reminder to the user U1 in a manner similar to the process PR7 (a process PR12).

The user U1 completes the procedure to be done by the user U1 (the procedure WK2) in response to the reminder. This completes the workflow.

Note that the MFP 100 may extend the normal range according to the reduction in remaining time before the deadline (an exemplary deadline of the completion of the workflow) in the process PR6 or PR11. This extension enables the MFP 100 to send a reminder to the next procedure worker even if the worker has a slightly higher level of stress. As a result, this can avoid a situation in which a reminder for a procedure fails to send to a next procedure worker for a long time.

FIG. 14 is a schematic diagram of another exemplary time variations in systolic blood pressure value of the user U1 monitored with the MFP 100 in the process PR11 according to the first embodiment of the present invention.

With reference to FIG. 14, the systolic blood pressure value of the user U1 who is the next procedure worker is beyond the normal range from 14:55 on Nov. 22nd, 2016 to 15:00 on the same day. Accordingly, the MFP 100 determines not to send a reminder during the time period. As a result, the MFP 100 fails to remind the user U1 to do the procedure although the remaining time before 16:00 on Nov. 22nd, 2016 that is the deadline prescribed in the workflow management table 121 (FIG. 8) is less than an hour.

In light of the foregoing, the MFP 100 extends the normal range of the systolic blood pressure value of the user U1 by 20 mm Hg to change the normal range to 142 mm Hg. As a result, the systolic blood pressure value of the user U1 gets into the normal range at 15:02 on Nov. 22nd, 2016, and thus the MFP 100 reminds the user U1 to do the procedure.

### Second Embodiment

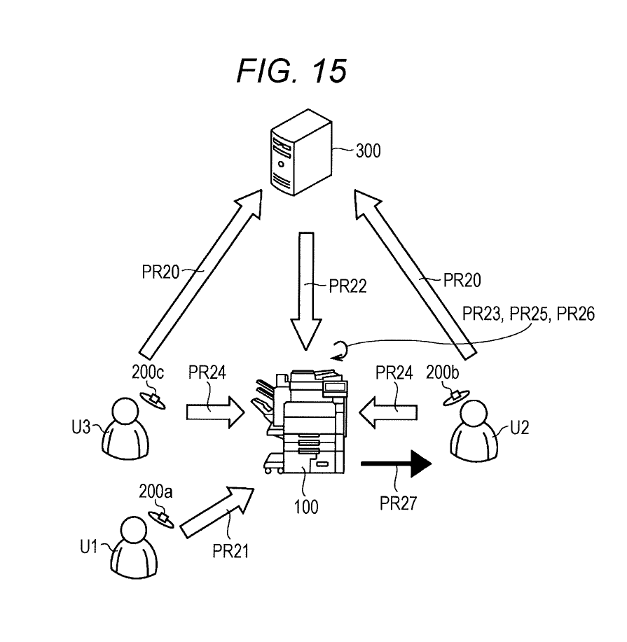

FIG. 15 is a diagram of an outline of an operation of the workflow management system according to the second embodiment of the present invention.

With reference to FIG. 5, the users U1, U2, and U3 wear the biological information terminals 200a, 200b, and 200c, respectively. When biometrically authenticating the wearer successfully, each of the biological information terminals 200a, 200b, and 200c transmits the measured systolic blood pressure value together with the user ID of the wearer at predetermined intervals (at one-minute intervals in this embodiment) to the biological information server 300 (a process PR20).

After the MFP 100 starts obtaining the systolic blood pressure value of each of the users U1, U2, and U3, the user U1 controls the operation panel 108 or the terminal 400 to register the workflow in which the users U2 and U3 are the workers on the MFP 100. The MFP 100 registers the workflow on the workflow management table 121 in response to the control by the user U1 (a process PR21).

The MFP 100 obtains the history of the systolic blood pressure value of each of the users U2 and U3, which is recorded before the registration of the workflow, from the biological information server 300 (a process PR22). Then, the MFP 100 determines the normal range of the systolic blood pressure value of each of the users U2 and U3 according to the obtained history of the systolic blood pressure value (a process PR23).

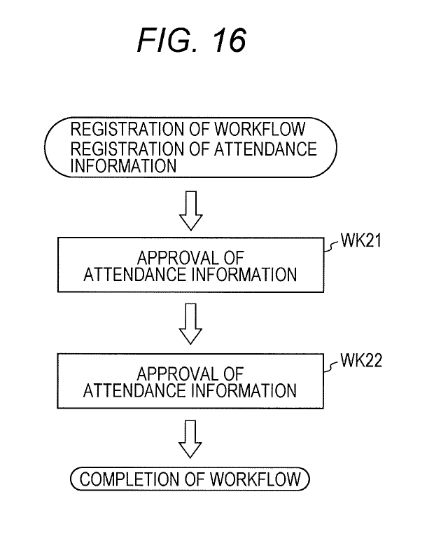

FIG. 16 is a schematic diagram of the content of the workflow to be registered by the user U1 in the second embodiment of the present invention.

With reference to FIGS. 15 and 16, it is assumed in the present embodiment that the user U1 requests the users U2 and U3 who are the user U1's supervisors to approve the attendance information about the user U1. The workflow to be registered by the user U1 includes the procedure in which the user U2 approves the attendance information (a procedure WK21) and the procedure in which the user U3 approves the attendance information after the approval by the user U2 (a procedure WK22).

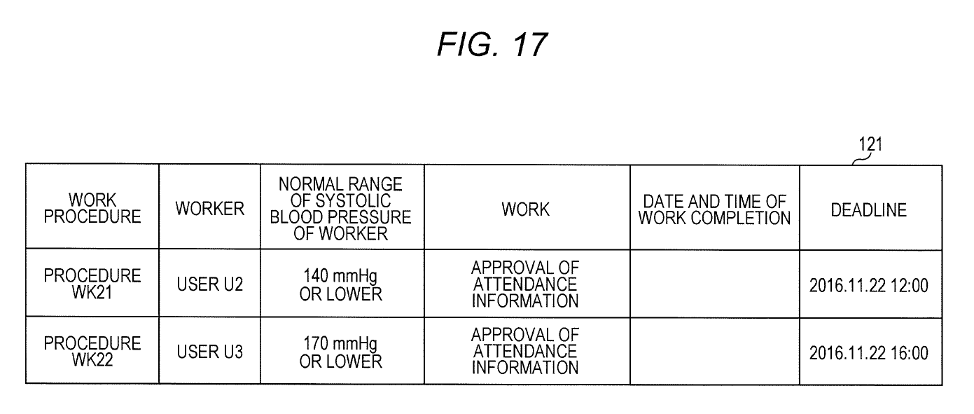

FIG. 17 is a schematic diagram of the workflow management table 121 immediately after the user U1 registers the workflow according to the second embodiment of the present invention.

The workflow in which the user U2 approves the attendance information in the procedure WK21, and the user U3 approves the attendance information in the procedure WK22 is written in the workflow management table 121 illustrated in FIG. 17. The fact that normal range of the systolic blood pressure value of the user U2 is “140 mm Hg or lower” and the normal range of the systolic blood pressure value of the user U3 is “170 mm Hg or lower” is also written. Furthermore, the fact that the deadline of the procedure WK21 is “12:00 on Nov. 22nd, 2016” and the deadline of the procedure WK22 is “16:00 on Nov. 22nd, 2016” is also written.

With reference to FIG. 15, when receiving the registration of the workflow, the MFP 100 starts monitoring the systolic blood pressure value of each of the users U2 and U3 who are the workers to do the workflow (a process PR24).

When receiving the registration of the workflow, the MFP 100 determines whether the workflow is stagnant (a process PR25).

It is assumed in the present embodiment that the procedure to be done by the user U2 (the approval of the attendance information illustrated in FIG. 16 (the procedure WK21)) in the workflow is not completed, and the next procedure worker who is the worker to do the next work in the workflow is the user U2.

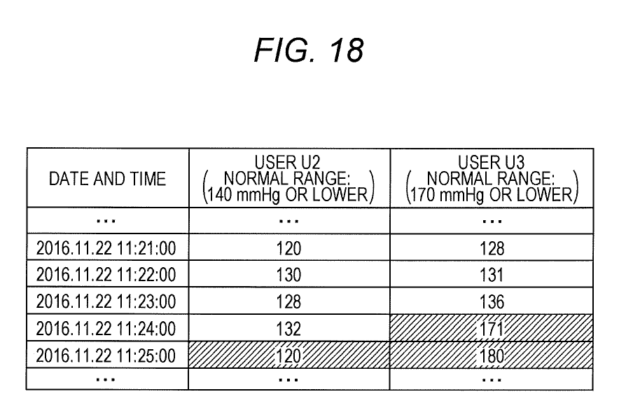

FIG. 18 is a schematic diagram of time variations in systolic blood pressure value of each of the users U2 and U3 monitored with the MFP 100 in the process PR25 according to the second embodiment of the present invention.

With reference to FIGS. 15 and 18, the MFP 100 determines that the workflow is stagnant in the present embodiment when the biological information about the user U3 who is the worker to do the procedure after the next procedure (the procedure-after-next worker) is beyond the normal range.

In specific, the systolic blood pressure value of the user U3 is beyond the normal range at 11:24 on Nov. 22nd, 2016. Thus, the MFP 100 determines that the workflow is stagnant at the time because the user U3, who is to do the procedure after the next procedure, is presumed to be frustrated and feel stressed at the stagnation of the workflow.

When determining that the workflow is stagnant, the MFP 100 determines whether to remind the user U2 to do the procedure, according to whether the systolic blood pressure value of the user U2 is within the normal range (a process PR26).

In specific, the systolic blood pressure value of the user U2 is within the normal range at 11:25 on Nov. 22nd, 2016 after it is determined that the workflow is stagnant. Thus, the MFP 100 determines to send a reminder at that time.

With reference to FIG. 15, when determining to remind the user U2 to do the procedure, the MFP 100 uses the display of a message or a sound for the reminder (a process PR27).

Note that the configuration and the operations other than the above-described operation of the workflow management system are similar to the configuration and operations of the workflow management system according to the first embodiment. Thus, the descriptions will not be repeated.

[Flowchart of Operation of MFP 100]

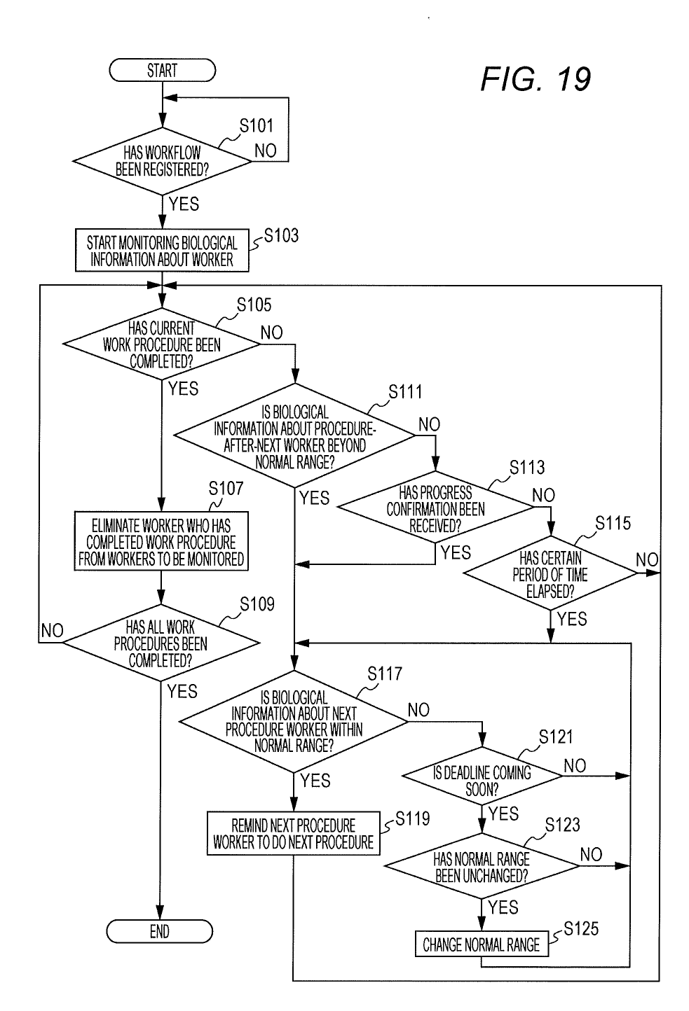

FIG. 19 is a flowchart of an operation of the MFP 100 according to each of the first and second embodiments of the present invention. The flowchart is performed when the CPU 101 loads an application program for managing a workflow stored on the storage device 104 onto the RAM 103.

With reference to FIG. 19, when the MFP 100 is turned on, the CPU 101 of the MFP 100 determines whether to receive the registration of a workflow (S101). The CPU 101 repeats the process of step S101 until receiving the registration of a workflow.

In step S101, when determining that the registration of a workflow is received (YES in S101), the CPU 101 determines the normal range of the biological information about the worker of the workflow, and starts monitoring the biological information (S103). Next, the CPU 101 determines whether the current procedure is completed (S105).

When determining in step S105 that the current procedure is completed (YES in S105), the CPU 101 eliminates the worker of the completed procedure from the workers to be monitored (S 107). Next, the CPU 101 determines whether all the procedures of the workflow have been completed (S109).

When determining in step S109 that all the procedures of the workflow has been completed (YES in S109), the CPU 101 terminates the process. On the other hand, when determining in step S109 that all the procedures of the workflow have not been completed (NO in S109), the CPU 101 goes to the process of step S105.

When determining in step S105 that the current procedure is completed (NO in S105), the CPU 101 determines whether the biological information about the procedure-after-next worker is beyond the normal range (S111).

When determining in step S111 that the biological information about the procedure-after-next worker is not beyond the normal range (NO in S111), the CPU 101 determines whether the progress confirmation of the workflow has been received (S113).

When determining in step S113 that the progress confirmation of the workflow has not been received (NO in S113), the CPU 101 determines whether a certain period of time has elapsed after the procedure to be done next is allowed to be done (S115).

When determining in step S115 that a certain period of time has not elapsed after the procedure to be done next is allowed to be done (NO in S115), the CPU 101 goes to the process in step S105.

When determining in step S111 that the biological information about the procedure-after-next worker is beyond the normal range (YES in S111), when determining in step S113 that the progress confirmation of the workflow has been received (YES in S113), or when determining in step S115 that a certain period of time has elapsed after the procedure to be done next is allowed to be done (YES in S115), the CPU 101 determines whether the biological information about the worker of the procedure to be done next (the next procedure worker) is within the normal range (S117).

When determining in step S117 that the biological information about the next procedure worker is within the normal range (YES in S117), the CPU 101 reminds the next procedure worker to do the procedure (S119), and goes to the process in step S105.

When determining in step S117 that the biological information about the next procedure worker is not within the normal range (NO in S117), the CPU 101 determines whether the deadline of the current procedure is coming soon (S121).

When determining in step S121 that the deadline of the current procedure is coming soon (YES in S121), the CPU 101 determines whether the normal range of the next procedure worker has been unchanged (S123).

When determining in step S123 that the normal range of the next procedure worker has been unchanged (YES in S123), the CPU 101 changes the normal range of the next procedure worker (S125), and goes to the process of step S117.

When determining in step S121 that the deadline of the current procedure is not coming soon (NO in S121), or when determining in step S123 that the normal range of the next procedure worker has been changed (NO in S123), the CPU 101 goes to the process of step S117.

[Modification]

The procedure order included in a workflow is determined in the embodiments. However, the procedure order included in a workflow is not necessarily determined. In such a case, the workflow management system may operate in a manner described below.

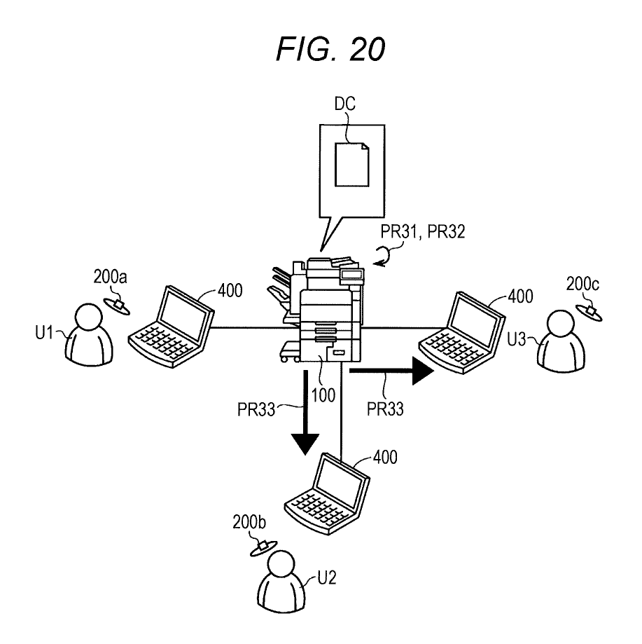

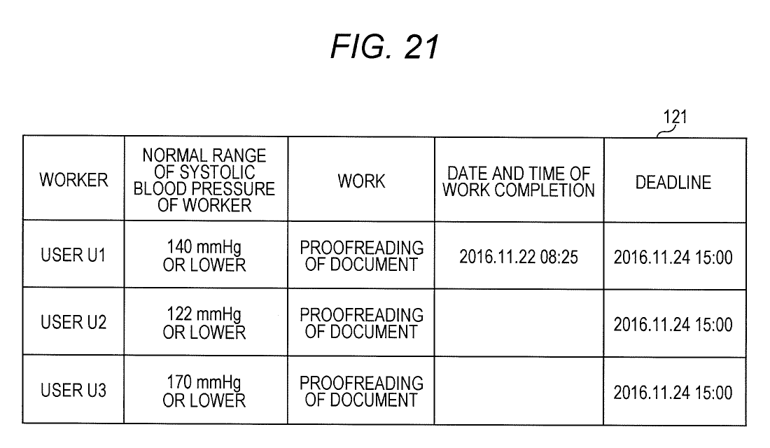

FIG. 20 is a diagram of an outline of an operation of a workflow management system according to a modification of the first and second embodiments of the present invention. FIG. 21 is a schematic diagram of the content of a workflow to be registered by the user U1 in the modification of the first and second embodiments of the present invention.

With reference to FIGS. 20 and 21, it is assumed in the present embodiment that the user U1 stores a document DC on the storage device 104 of the MFP 100 and requests the users U1, U2, and U3 to proofread the document with terminals 400. The order of procedures of the workflow is not determined, and thus each of the users U1, U2, and U3 who are the workers can do the worker's procedure at an arbitrary timing before the deadline.

When the MFP 100 receives input for confirming the progress of the workflow, or when the period of time elapsed since the procedure to be done next has been allowed exceeds a certain period of time, the MFP 100 determines that the workflow is stagnant (a process PR31). When determining that the workflow is stagnant, the MFP 100 determines whether to remind each of the users U2 and U3 to do the procedure, according to whether the systolic blood pressure value of each of the users U2 and U3 who have not done their procedures is within the normal range (a process PR32). When determining to remind each of the users U2 and U3 to do the procedure, the MFP 100 sends a reminder to the terminal 400 that each of the users U2 and U3 logs in (a process PR33).

[Effects of Embodiments]

According to the embodiments and modification described above, it is determined whether to remind a worker who makes the workflow stagnant to do the procedure according to the biological information obtained from a worker of the workflow. This enables a reminder for the procedure to be sent at a good timing and thus make such a reminder efficient. In particular, a worker who makes a workflow stagnant is reminded to do the procedure when the biological information obtained from the worker is within the normal range. This enables a reminder to be sent at a timing at which the worker is presumed to be able to easily deal with the reminder.

[Other Modifications]

The MFP 100 needs at least obtaining the biological information about at least one of the workers of the workflow from the biological information terminal 200 that at least one of the worker wears, in order to determine whether to remind the next procedure worker to do the procedure according to the obtained biological information.

The embodiments and modifications can properly be combined.

The processes in the embodiments may be performed with software or a hardware circuit. Alternatively, a program for performing the processes in the embodiments can be provided, and the program may be stored on a recording medium such as a CD-ROM, a flexible disk, a hard disk, a ROM, a RAM, or a memory card to provide the program to the user. The program is executed with a CPU of a computer. Alternatively, the program may be downloaded onto a device via a communication line such as the Internet.

Although embodiments of the present invention have been described and illustrated in detail, it is clearly understood that the same is by way of illustration and example only and not limitation, the scope of the present invention should be interpreted by terms of the appended claims. The scope of the present invention is intended to include all changes in the meanings and scopes equivalent to the scope of claims.

What is claimed is:

1. A workflow management apparatus that manages a registered workflow, wherein a work procedure order is associated with a work procedure and a worker who is to do the work procedure in the workflow, the workflow management apparatus comprising:
a hardware processor that:
obtains biological information, the biological information being read with a biological information reading device for reading biological information about a wearer of the device, the biological information being about at least a worker of the workflow;
identifies a next procedure worker who makes the registered workflow stagnant when the workflow is stagnant; and
determines according to the biological information whether to remind the next procedure worker to do a procedure.

2. The workflow management apparatus according to claim 1,
wherein the hardware processor determines a specific range of the obtained biological information, and
determines whether to send a reminder according to whether the biological information is within the specific range.

3. The workflow management apparatus according to claim 2,
wherein the hardware processor obtains a history of the biological information about at least a worker of the workflow, and
determines the specific range according to the history.

4. The workflow management apparatus according to claim 2,
wherein the hardware processor determines a normal range of the biological information about a worker as the specific range.

5. The workflow management apparatus according to claim 1,
wherein the hardware processor determines that the workflow is stagnant when the hardware processor receives input for confirming progress of the workflow.

6. The workflow management apparatus according to claim 1,
wherein the hardware processor measures a period of time elapsing since a procedure to be done next is allowed to be done, and
determines that the workflow is stagnant when the elapsing period of time exceeds a certain period of time.

7. The workflow management apparatus according to claim 1,
wherein the hardware processor obtains the biological information about a procedure-after-next worker who is to do a procedure after the procedure to be done next, and
determines that the workflow is stagnant when the biological information about the procedure-after-next worker is beyond the specific range.

8. The workflow management apparatus according to claim 2,
wherein the hardware processor extends the specific range according to reduction in remaining time before a deadline of completion of a procedure of the workflow.

9. The workflow management apparatus according to claim 1,
wherein the hardware processor reminds the next procedure worker to do a procedure when the hardware processor determines to remind the next procedure worker to do the procedure.

10. The workflow management apparatus according to claim 9,
wherein the hardware processor sends a reminder to at least one of the biological information reading device that the next procedure worker wears and a device that the next procedure worker logs in with the worn biological information reading device when the hardware processor determines to remind the next procedure worker to do the procedure.

11. The workflow management apparatus according to claim 1,
wherein the hardware processor starts obtaining the biological information about at least a worker of a workflow when the hardware processor receives registration of the workflow.

12. The workflow management apparatus according to claim 1,
wherein the hardware processor stops obtaining the biological information about a worker who has completed a procedure of the workflow.

13. The workflow management apparatus according to claim 1,
wherein there is a plurality of workers of the workflow, and
the hardware processor obtains the biological information about all of the workers of the workflow from each of the biological information reading devices that all of the workers of the workflow wear.

14. The workflow management apparatus according to claim 1,
wherein a worker to do a final procedure in the workflow is a worker who has registered the workflow.

15. The workflow management apparatus according to claim 1,
wherein the workflow includes a plurality of procedures using the workflow management apparatus.

16. The workflow management apparatus according to claim 1,
wherein the workflow management apparatus is an image forming apparatus.

17. A non-transitory recording medium storing a computer readable program executed by a workflow management apparatus that manages a registered workflow, wherein a work procedure order is associated with a work procedure and a worker who is to do the work procedure in the workflow, the program causing a computer to perform:
obtaining biological information, the biological information being read with a biological information reading device for reading biological information about a wearer of the device, the biological information being about at least a worker of the workflow;
identifying a next procedure worker who makes the registered workflow stagnant when the workflow is stagnant; and
determining according to the biological information whether to remind the next procedure worker to do a procedure.
